(19) United States
(12) Patent Application Publication
(10) Pub. No.: US 2004/0051669 A1
(43) Pub. Date: Mar. 18, 2004

(54) Antenna arrangement and a portable radio communication device

(76) Inventors: Tomas Rutfors, Sollentuna (SE); Christian Braun, Stockholm (SE); Henrik Falken, Lidingo (SE); Lennart Hakansson, Brottby (SE); Liu Donghui, Taby (SE)

Correspondence Address: JACOBSON HOLMAN PLLC, 400 SEVENTH STREET N.W., SUITE 600, WASHINGTON, DC, 20004, US

(21) Appl. No.: 10/312,563

(22) PCT Filed: Jul. 10, 2001
(86) PCT No.: PCT/SE01/01602

(30) Foreign Application Priority Data
Jul. 10, 2000 (SE) 0002600-5

(51) Int. Cl. H01Q 1/24; H01Q 13/10; H01Q 1/38

(52) U.S. Cl. 343/702; 343/700 MS; 343/767

(57) ABSTRACT

An antenna arrangement for a portable radio communication device, comprising a first (1) and a second (2) antenna element, and a conductive shield (4) connectable to a ground plane device (3), said first (1) and second (2) antenna elements are located on opposite sides of the shield (4), wherein said first (1) and second (2) antenna elements are of different types.

### FIELD OF INVENTION

The present invention relates generally to antenna arrangements and particularly to coupling between closely spaced antennas in portable radio communication devices.

### BACKGROUND

In a portable radio communication device the space for an internal antenna arrangement is limited. With the growing need for greater functionality and better radio channel quality it is often necessary to utilize more than one antenna element in a portable radio communication device, such as a mobile telephone. As the space in a portable radio communication device is limited, internal antennas tend to be closely spaced. With closely spaced antenna elements unwanted coupling between the antennas can arise.

In WO 9013152 it is disclosed that separated transmit and receive antennas are used to eliminate the need for a diplexer. The antennas are elevated above a grounding surface and separated by a conductive pedestal, wherein the pedestal is placed between the antennas and electrically isolates the antennas. WO 9013152 mentions only the case of two antennas of the same type (two similar patches).

The above-described document only describes reduced coupling between separated transmit and receive antennas.

### SUMMARY OF THE INVENTION

An object of the present invention is to provide an antenna arrangement that offers improved isolation, i.e. decreased coupling, between antennas in a portable radio communication device, such as a mobile telephone.

This object is achieved by an arrangement as claimed in claim 1.

A further object of the present invention is to provide a portable radio communication device, such as a mobile telephone, that offers improved isolation between antennas inside said device.

This object is achieved by a device as claimed in claim 14.

Two antennas of different types, such as a PIFA and a meander antenna, have low coupling between them and can be closely spaced. Closely spaced antennas with low coupling can be used for various applications. These can be for example: separate receive and transmit antenna systems that eliminate the need for a diplexer, antenna diversity systems (both receiver and transmitter diversity), and antennas for different systems (e.g. GSM-Bluetooth).

With a shield between internal antennas in a portable radio communication device the coupling between the antennas is reduced and therewith it is possible to place the antennas close to each other. Further, with internal antennas of different types, such as meander antenna and PIFA, the coupling between the antennas are less than with two antennas of the same type, such as PIFA and PIFA. Thus two antennas of different types and separated by a shield can be positioned closer together than two of the same type separated by a shield, still providing the same amount of isolation.

Advantages and features of the present invention will be evident from the following detailed description of embodiments.

### BRIEF DESCRIPTION OF THE DRAWINGS

The present invention will become more fully understood from the detailed description of embodiment of the present invention given below and the accompanying figure, which are given by way of illustration only, and thus are not limitative of the present invention, wherein:

FIG. 1 shows a portable terminal PCB carrying a PIFA antenna at the top and a meander antenna below, and

FIG. 2 shows a portable terminal PCB carrying a PIFA to the right and a meander antenna to the left.

### DETAILED DESCRIPTION OF EMBODIMENTS

In the following description, for purpose of explanation and not limitation, specific details are set forth, such as particular techniques and applications in order to provide a thorough understanding of the present invention. However, it will be apparent to one skilled in the art that the present invention may be practiced in other embodiments that depart from these specific details. In other instances, detailed descriptions of well-known methods and apparatuses are omitted so as not to obscure the description of the present invention with unnecessary details.

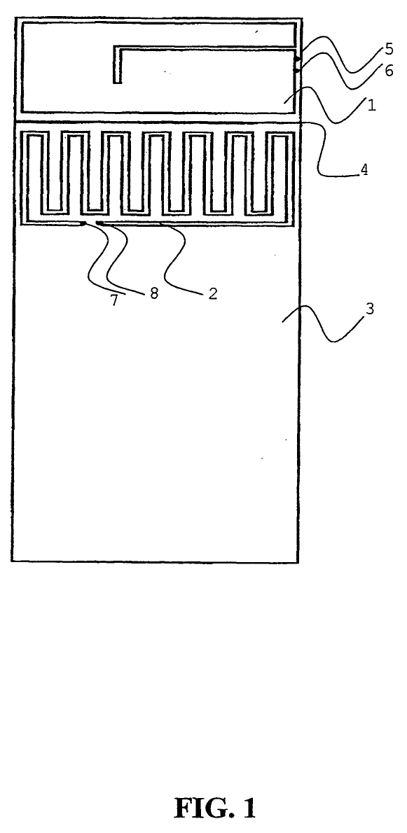

A first embodiment of the present invention will now be described with reference to FIG. 1. A first and a second antenna element 1, 2 are connected to a ground plane device 3, i.e. the PCB of a portable radio communication device, such as a mobile telephone. The first antenna element 1 is here shown as a PIFA (Planar Inverted F Antenna) and the second antenna element 2 as a meander antenna. The PIFA is further connected 5, 6 to transmit/receive circuitry (not shown) of the portable radio communication device. Also the meander antenna is connected 7, 8 to transmit/receive circuitry (not shown) of the portable radio communication device, but with its connections 7, 8 distanced from the connections 5, 6 of the PIFA.

The PIFA 1 and meander 2 antenna elements are positioned close to each other so as to take up as little space as possible in the portable radio communication device. A conductive shield 4, extending from the ground plane device 3, is positioned between the antennas 1, 2. The shield 4 provides additional isolation, and thereby reduces the coupling between the antennas 1, 2, which is usually present between closely spaced antennas. Since the coupling is reduced it is possible to position the antennas 1, 2 closer to each other than without the shield 4.

The PIFA antenna 1 and the meander antenna 2 are of different types, so that the field distributions, or equivalently current distributions, are different. The meander antenna 2 has its currents essentially concentrated around the actual antenna element, while the PIFA currents are distributed more on the ground plane device 3. This difference has the effect that the coupling between the antennas is small and the antennas can be closely positioned. The screen 4 is grounded and elevated over the ground plane device 3, forcing the currents passing it to change direction (up onto the screen). This additionally reduces the amount of current flowing on the PCB from one antenna to the other, thus minimizing the coupling between the antennas.

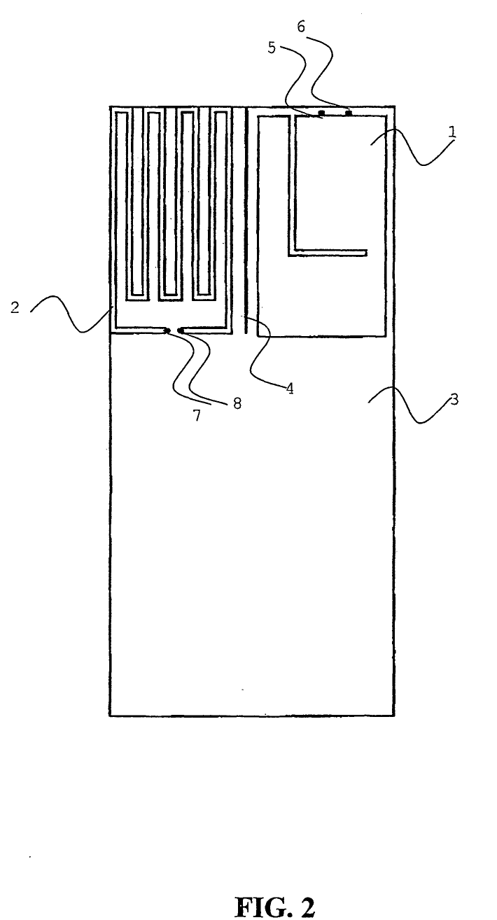

A second embodiment of the present invention will now be described with reference to FIG. 2. This embodiment is similar to the first embodiment, but the antennas 1, 2 are placed side by side instead of above and below. The shield 4 is still placed between the antennas 1, 2. The feeding of the PIFA antenna element 1 is positioned at the top of the PCB 3, while the meander antenna element 2 is fed at its lower end. The separation of feeding points has the effect that the current distribution from each antenna is different, which provides isolation between the antennas. This effect is further enhanced by the shield 4 between the antennas.

In these embodiments, the antennas 1, 2 are suitable for dual-band operation. It is possible to reduce or extend the number of frequency bands of the antennas by changing the design of the antenna patterns.

In the embodiments described above the PIFA antenna 1 is preferably optimized as a receiver antenna and the meander antenna 2 as a transmit antenna. However, with slightly different designs, both antennas could be optimized for transmission or reception, providing a transmitter or a receiver antenna diversity system, respectively.

The antennas may further be optimized individually in different frequency bands, such as GSM900 and GSM1800, or in different communication systems, such as GSM and Bluetooth.

It is above described that the antennas 1, 2 and the shield 4 are connected to the PCB of the portable radio communication device, which is the case when the antennas 1, 2 and the shield 4 are mounted in the portable radio communication device, otherwise the antennas 1, 2 and the shield 4 are connectable to a ground plane device. Alternatively the antennas 1, 2 and the shield 4 may be mounted on a separate ground plane device, which is connectable to the PCB when mounted in the portable radio communication device.

The coupling between two antennas is dependent on the fields radiated by the antennas. If the fields are different, e.g. different radiation pattern, different polarization, different phase, etc., the coupling will be low. A measure of the coupling between two antennas is to integrate the scalar product of the radiated fields from each antenna over a sphere enclosing both antennas. This measure can be seen as an orthogonality factor between the antennas. The radiated field from an antenna is made up of the currents flowing on the conducting parts of the antenna and its surroundings, e.g. ground. Therefore, the more different the currents associated with each antenna the lower coupling between them.

The antennas in the description above can as well be other antenna types than described. The antennas can e.g. be PIFA, meander, modified PIFA, meander PIFA, loop, dipole, patch, and slot antennas. The important part is that the antennas are somewhat different, having different current distributions on the ground plane device, e.g. the PCB, so that the coupling between the antennas is low. The conductive screen helps to alter the current distribution, which makes the coupling even lower.

The antennas described above may be matched and adjusted in ways known by a person skilled in the art.

It will be obvious that the present invention may be varied in a plurality of ways. Such variations are not to be regarded as a departure from the scope of the invention. All such modifications as would be obvious to one skilled in the art are intended to be included within the scope of the appended claims.

1. An antenna arrangement for a portable radio communication device, comprising:
a first (1) and a second (2) antenna element, and
a conductive shield (4) connectable to a ground plane device (3), wherein said first (1) and second (2) antenna elements are located on opposite sides of the shield (4),
characterized in that
said first (1) and second (2) antenna elements are of different types.

2. The antenna arrangement as claimed in claim 1, wherein said antenna arrangement is mountable in said portable radio communication device, such that the shield (4) is essentially perpendicular to said ground plane device (3).

3. The antenna arrangement as claimed in claim 1 or 2, wherein said first (1) and second (2) antenna elements are each adapted to be able to transmit and receive radio signals.

4. The antenna arrangement as claimed in claim 1 or 2, wherein said first (1) antenna element is adapted to be able to transmit radio signals and said second (2) antenna element is adapted to be able to receive radio signals.

5. The antenna arrangement as claimed in claim 1 or 2, wherein said first (1) antenna element is adapted to be able to receive and transmit radio signals and said second (2) antenna element is adapted to be able to receive radio signals.

6. The antenna arrangement as claimed in claim 1 or 2, wherein said first (1) antenna element is adapted to be able to receive and transmit radio signals and said second (2) antenna element is adapted to be able to transmit radio signals.

7. The antenna arrangement as claimed in claim 1 or 2, wherein said first (1) antenna element is adapted to be able to transmit radio signals and said second (2) antenna element is adapted to be able to receive and transmit radio signals.

8. The antenna arrangement as claimed in claim 1 or 2, wherein said first (1) and second (2) antenna elements are each adapted to be able to transmit radio signals.

9. The antenna arrangement as claimed in claim 1 or 2, wherein said first (1) and second (2) antenna elements are each adapted to be able to receive radio signals.

10. The antenna arrangement as claimed in claim 1 or 2, wherein said first (1) antenna element is adapted to be able to receive radio signals and said second (2) antenna element is adapted to be able to receive and transmit radio signals.

11. The antenna arrangement as claimed in claim 1 or 2, wherein said first (1) antenna element is adapted to be able to receive radio signals and said second (2) antenna element is adapted to be able to transmit radio signals.

12. The antenna arrangement as claimed in any of claims 1-11, wherein said first (1) and second (2) antenna elements are mountable within said portable radio communication device.

13. The antenna arrangement as claimed in any of claims 1-12, wherein said first (1) antenna element is one of the following types: PIFA, meander, loop, patch, dipole, slot, modified PIFA, meander PIFA; and said second (2) antenna element is one of the following types: PIFA, meander, loop, patch, dipole, slot, modified PIFA, meander PIFA; but not the same type as said first (1) antenna element.

14. A portable radio communication device, comprising an antenna arrangement as claimed in any previous claim.

15. The portable radio communication device as claimed in claim 14, wherein said ground plane device (3) is the PCB of the portable radio communication device.
